(19) United States
(12) Patent Application Publication
(10) Pub. No.: US 2009/0092649 A1
(43) Pub. Date: Apr. 9, 2009

(54) Method and apparatus for imparting a biocidal agent

(76) Inventor: E. Bertram Berkley, Mission Hills, KS (US)

Correspondence Address: LATHROP & GAGE LC, 2345 GRAND AVENUE, SUITE 2800, KANSAS CITY, MO, 64108, US

(21) Appl. No.: 11/001,541

(22) Filed: Dec. 1, 2004

Related U.S. Application Data
(60) Provisional application No. 60/525,937, filed on Dec. 1, 2003.

(51) Int. Cl. A01N 25/34; A01P 1/00

(52) U.S. Cl. 424/412

(57) ABSTRACT

A method and an apparatus is disclosed for using a biocidal agent associated with a sheet of material on a food item subsequent packaging of the item to maintain product properties in packaged beverages and foods. The method includes providing a sheet for imparting a biocidal activity to a food product. The sheet has a biological agent associated therewith in an amount sufficient to render it resistant to attack from organisms and in an amount that the sheet imparts biocidal activity in an area surrounding the sheet. The sheet further has at least one line of weakness to define two or more strips on the sheet, each strip having the biological agent associated therewith and each strip being selectively separable from the sheet.

### RELATED APPLICATIONS

This application claims priority to U.S. Provisional Patent Application Ser. No. 60/525,937, filed Dec. 1, 2003, the disclosure of which is incorporated herein by reference.

### BACKGROUND OF THE INVENTION

This invention relates to the preservation of food products, and more specifically to methods and apparatus for preserving the freshness and thus maintaining or enhancing the flavor of perishable food items.

### DESCRIPTION OF THE RELATED ART

One method currently being used for regulating freshness is through regulating the oxygen exposure of the food though “active packaging.” In this case, the package containing the food product has been modified by the manufacturer to regulate the food's exposure to oxygen. One form of active packaging uses oxygen-scavenging sachets or bags that contain a composition which scavenges the oxygen through oxidation reactions. However, a disadvantage of sachets is the toxicity if consumers accidentally ingest the sachet.

Further, it is known to use a coated paper or cardboard stock to act as an oxygen barrier. A more uniform scavenging effect through the package is achieved by incorporating the scavenging material in the package instead of adding a separate scavenger structure (e.g., a sachet) to the package. In addition, incorporating the oxygen scavenger into the package structure provides a means of intercepting and scavenging oxygen as it permeates the walls of the package (herein referred to as an “active oxygen barrier”), thereby maintaining the lowest possible oxygen level in the package. Limited success has been achieved in incorporating oxygen scavenging material into the walls of packages for various types of food.

One attempt to prepare an oxygen-scavenging wall involves the incorporation of inorganic powders and/or salts. However, incorporation of these powders and/or salts causes reduction of the wall's optical transparency, discoloration after oxidation, and reduced mechanical properties such as tear strength. In addition, these compounds can lead to processing difficulties, especially when fabricating thin films. And further, the oxidation products, which can be absorbed by food in the container, typically would not have FDA approval for human consumption.

Recently, paper (sheets or pellets) impregnated with biocidal agents have been developed to impart biocidal activity, such as creating a no-growth zone on the surface of and immediately surrounding the paper. In this manner, chemically impregnated paper promote sterile environments useful for a wide variety of activities, for example in the treatment of illness/injury, or in the packaging/storage of foodstuffs.

In another embodiment, paper has been impregnated with sodium diacetate to impart biocidal activity. This application discloses its application with envelopes in an attempt to control terrorist attacks through the mail.

Sodium diacetate is well known as a food additive. It is highly efficacious in mould inhibition, antisepsis, fresh preservation and nutritive value addition and a flavor enhancer. Further, it can be used as an efficient mould inhibitor, an antiseptic agent, a freshness preserver and a nutrition improver in grain storage, and feed or food production. It has the advantages of low cost, superior effectiveness, convenience of use and no toxicity.

The present invention solves many of the problems of the prior art encountered when biodical or oxygen scavenging material have been incorporated into packaging materials. Other objects, advantages, features and results will more fully appear in the course of the following description.

### SUMMARY OF THE INVENTION

The present invention provides a method and an apparatus for using a biocidal agent associated with a sheet of material on a food item subsequent packaging of the item to maintain product properties in packaged beverages and foods. The method includes providing a sheet for imparting a biocidal activity to a food product, the sheet comprising a biological agent associated with the sheet in an amount sufficient to render it resistant to attack from organisms and such that the sheet imparts biocidal activity in an area surrounding the sheet. The sheet further has at least one line of weakness to define two or more strips on the sheet, each strip having the biological agent associated therewith and each strip being selectively separable from the sheet. The method further including the steps of removing one strip from the sheet; opening the package containing the products, and inserting the strip in the package.

### BRIEF DESCRIPTION OF THE DRAWINGS

FIG. 1 is a side elevational view of a sheet having a biocidal agent of the present invention and a deactivation layer being lifted therefrom;

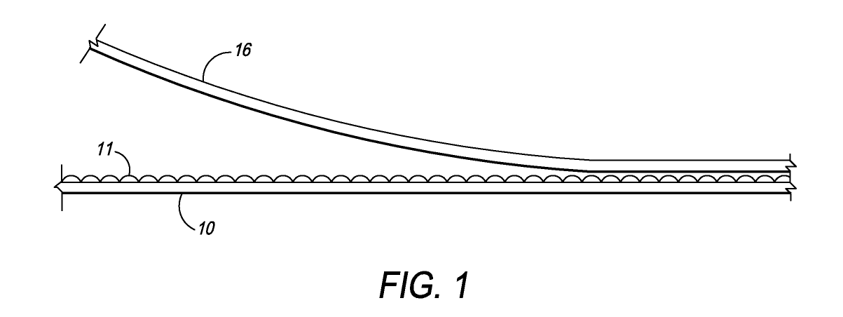

FIG. 2 is a top view of a sheet of the present invention having lines of weakness formed thereon and having an adhesive on an inner surface thereof; and

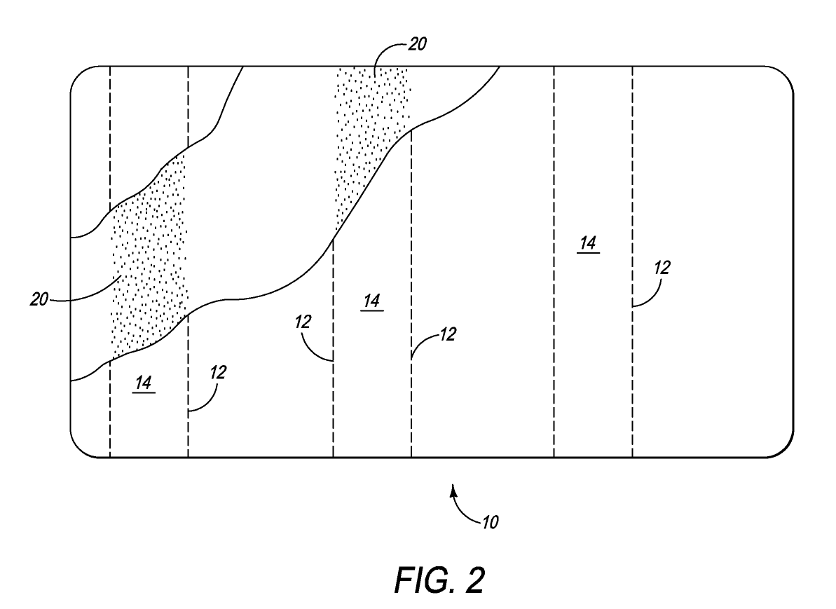

FIG. 3 is a perspective view of a strip of the present invention adhered to packaging.

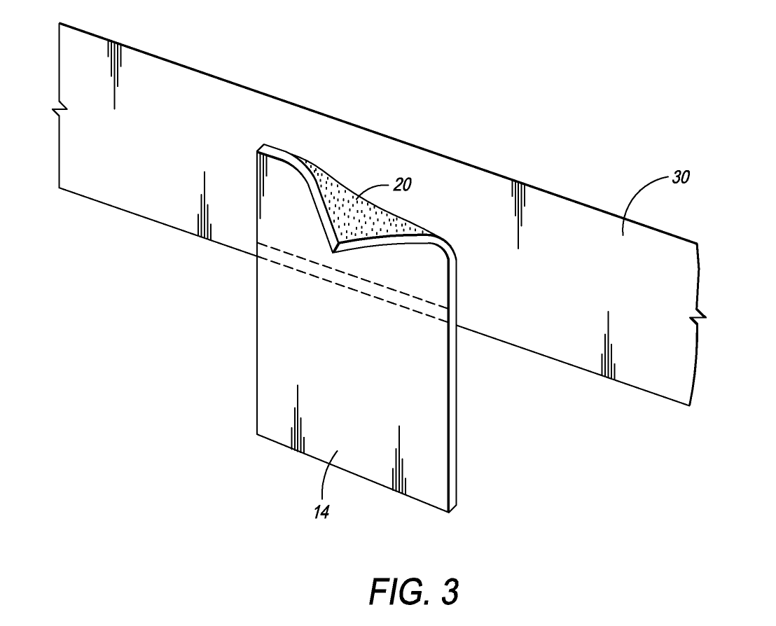

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention discloses a desirable laminate structure having biocide associated with the laminate. The laminate structure is configured such that a consumer may add the structure to packaging material to easily protect food items or other perishable commodities from attack or deterioration cause by various organisms after purchase of the food items or perishable commodities. The biocide can be associated with the laminate in any one of a variety of ways, so that an amount is present which is effective to render the laminate resistant to attack by such organisms. The specific method for associating the biocide with the laminate will vary depending upon the form of the laminate and is known by those skilled in the art.

The laminate structure typically includes a paper layer and the biocide is generally applied to the paper layer before cold laminating the paper to a plastic film or films. The methods of manufacturing biocidal laminates is disclosed in U.S. Pat. Application No. 2004-0071902, the entire content of which is expressly incorporated herein by reference.

The present invention is directed to a sheet of paper generally indicated at 10. The sheet of paper 10 has a biocidal agent 11, such as sodium diacetate, associated therewith using known methods as previously disclosed. The sheet 10 includes lines of weakness 12, such as perforations, to facilitate the separation of the sheet 10 into individual strips 14 with each strip impregnated by the biocidal agent.

The impregnated strip 14 is operably sized and configured to be easily handled by a consumer and further is sized and configured to prevent ingestion by a human. Preferably, the strip is rectangularly shaped, but it will be understood by those skilled in the art that the strip can be shaped as a circle, a square or any other convenient shape.

Preferably, the sheet of paper further includes a deactivation coating, layer or laminate 16 that prevents or slows down the release of the biocidal agent until such time that the biocidal properties are needed. For example, the sheet 10 may be provided with a plastic face sheet that prevents the release of the biocidal agent. It will be understood by those skilled in the art that there are other means of controlling the release of the biological agent until such time that those properties are desired. The layer and laminate would be formed to have either lines of weakness that are aligned with the lines of weakness of the paper, or as would be the case with a coating, would be readily separable at the lines of weakness of the sheet 10 such that individual strips may be separated from the sheet 10.

In an alternative embodiment, one surface of the sheet 10 further comprises an adhesive layer 20. The layer may comprise any suitable non-toxic, pressure-sensitive, self-adhesive material, such as acrylic adhesive, which is releasable for repositioning purposes and which leaves little or no residue. The adhesive layer may include an active portion that would adhere to any suitable surface and an inactive portion where the adhesive has been neutralized with a suitable deadening agent.

It will be further understood by those skilled in the art that the sheet of paper 14 may be a label sheet (not shown) embodying the present invention. In such an embodiment, the label sheet comprise a face layer and a liner. The face layer and the liner are adhesively bonded and the label sheet is formed according to known manufacturing methods. The face layer is impregnated with the biocidal agent and a cut pattern is formed on the label sheet to form individual, discrete labels or stickers with biocidal properties. An adhesive layer is applied to the face layer inner surface and can comprise any suitable non-toxic, pressure-sensitive, self-adhesive material, such as acrylic adhesive, which is releasable for repositioning purposes and which leaves little or no residue.

The present invention can be practiced in the following unique manner. After purchasing or taking delivery of foodstuff, such as a package of hamburger buns, the consumer or restaurant employee, may remove a strip 14 or label from the sheet 10 or label sheet of the present invention. The consumer removes any deactivation laminate or layer, or otherwise activates the biocidal properties of the strip and then inserts or attaches the strip into the packaging 30.

This novel method thus imbues a consumer with the ability to affect the freshness and the shelf life of purchased food products The invention does not need to be incorporated during the manufacture of the packaging, thus saving cost.

It is to be understood that while certain forms of the present invention have been illustrated and described herein, it is not to be limited to the specific forms or arrangement of parts described and shown.

What is claimed is:

1. A sheet for imparting a biocidal activity to a food product, the sheet comprising:
a biological agent impregnated in the sheet such that the agent as released imparts biocidal activity in an area surrounding the sheet,
the sheet having at least one line of weakness defining two or more strips on the sheet, each strip being impregnated with the biological agent and each strip being selectively separable from the sheet.

2. A sheet according to claim 1 further comprising a deactivating component, the deactivating component inhibiting the release of the biocidal agent.

3. A sheet according to claim 2 wherein the deactivating component comprises a releasable layer mounted to the sheet to inhibit the biocidal agent, the layer being selectively releasable.

4. A sheet according to claim 1 further comprising a layer of adhesive on at least a portion of an inner surface of said strip; said layer of adhesive being non-toxic.

5. A sheet according to claim 1, wherein said sheet is operably sized and configured to prevent accidental ingestion by a consumer.

6. A sheet according to claim 1, wherein said sheet is a label sheet comprising a face layer and a liner, the face layer and the liner being releasably adhesively bonded and wherein the face layer is impregnated with the biocidal agent, the label sheet further comprising a cut pattern to form at least one label.

7. A method of using a biocidal agent on a food item subsequent packaging of the item to maintain product properties in packaged beverages and foods, the method comprising the steps of:
a. providing a sheet for imparting a biocidal activity to a food product, the sheet comprising a biological agent impregnated in the sheet such that the agent as released imparts biocidal activity in an area surrounding the sheet, the sheet further having at least one line of weakness to define two or more strips on the sheet, each strip being impregnated with the biological agent and each strip being selectively separable from the sheet.
b. removing one strip from the sheet
c. opening the package containing the products, and
d. inserting the strip in the package.

8. The method of claim 7 wherein the step of providing sheet for imparting a biocidal activity further comprises a releasable layer mounted to the sheet to inhibit the release of the biocidal agent, the layer being selectively releasable

9. The method of claim 8 further comprising the step of:
a. removing the layer from the strip prior to inserting the strip into the package.
